(19) United States
(12) Patent Application Publication
(10) Pub. No.: US 2026/0228068 A1
(43) Pub. Date: Aug. 6, 2026

(54) SYSTEM RESOURCE USAGE-BASED MAINTENANCE REMINDER

(71) Applicant: Dell Products L.P., Round Rock, TX (US)

(72) Inventors: Ibrahim Sayyed, Georgetown, TX (US); Balasingh Samuel, Round Rock, TX (US); Deeder Aurongzeb, Austin, TX (US)

(21) Appl. No.: 19/044,968

(22) Filed: Feb. 4, 2025

(51) Int. Cl. G06F 11/00

(52) U.S. Cl. CPC G06F 11/004; G06F 11/0703; G06F 2201/81

(57) ABSTRACT

An embodiment detects, in a system diagnostic service, that a system resource usage metric is above a threshold value. An embodiment generates, in the system diagnostic service, responsive to detecting that the system resource usage metric is above the threshold value, a dust filter maintenance notification.

### BACKGROUND

### Field of the Disclosure

The disclosure relates generally to an information handling system, and in particular, to a system resource usage-based maintenance reminder.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

Innovative aspects of the subject matter described in this specification may be embodied in a computer-implemented method of detecting, in a system diagnostic service, that a system resource usage metric is above a threshold value; and generating, in the system diagnostic service, responsive to detecting that the system resource usage metric is above the threshold value, a dust filter maintenance notification.

Other embodiments of these aspects include corresponding systems, apparatus, and computer programs, configured to perform the actions of the methods, encoded on computer storage devices.

Particular implementations of the subject matter described in this specification can be implemented so as to realize one or more of the following advantages. For example, performing maintenance when actually required can prevent system component failures (e.g., due to excess heat due to a dusty fan's inefficient operation) and support calls while avoiding premature maintenance or replacement of a system component that is performing as specified.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIG. 2 illustrates a block diagram of an information handling system for a system resource usage-based maintenance reminder, according to some embodiments.

FIG. 3 depicts a block diagram of an example configuration for a system resource usage-based maintenance reminder, in accordance with an illustrative embodiment.

FIG. 4 depicts an example of a system resource usage-based maintenance reminder, in accordance with an illustrative embodiment.

FIG. 5 depicts a flowchart of an example process for a system resource usage-based maintenance reminder. in accordance with an illustrative embodiment.

### DESCRIPTION OF PARTICULAR EMBODIMENT(S)

Many presently available information handling systems include a periodic maintenance reminder. The periodic maintenance reminder, when triggered at predetermined time intervals such as monthly, quarterly, or yearly, reminds a system user or administrator to perform a system chassis maintenance task. A system chassis maintenance task, as used herein, is a maintenance task performed on one or more physical components of an information handling system. A system chassis maintenance task, as used herein, does not include a maintenance task performed on one or more software components of an information handling system. Some non-limiting examples of a system chassis maintenance task are cleaning system ventilation openings, cleaning or replacing system air filters, replacing a user-serviceable component such as a system battery, adding coolant to a repository used in a liquid-cooled system, and the like.

However, periodic maintenance reminders at predetermined time intervals do not take into account varying system usage and workload durations. For example, if an information handling system spends twenty hours a day running a memory-, storage-, and processor-intensive gaming application, the system will experience higher-than-expected cooling cycles and a faster-than-expected dust accumulation on the system's fan. As another example, if an information handling system only operates for an hour a day, the system will experience lower-than-expected cooling cycles and a lower-than-expected dust accumulation on the system's fan. Therefore, the illustrative embodiments recognize that there is a need for a maintenance reminder that is automatically adjusted based on system resource usage.

This disclosure discusses methods and systems for a system resource usage-based maintenance reminder of an information handling system. In particular, an embodiment detects, in a system diagnostic service, that a system resource usage metric is above a threshold value; and generates, in the system diagnostic service, responsive to detecting that the system resource usage metric is above the threshold value, a dust filter maintenance notification.

A system diagnostic service is software that executes on a computer system, under an operating system. A system diagnostic service collects data on software executing in or installed in the computer system, such as usage data of system resources such as processor(s), memory, storage, and power or battery usage and status. In some embodiments, a system diagnostic service collects usage data of processes executing in the computer system and aggregates per-process usage data into overall usage data of resources within the system.

A system diagnostic service also collects data from an embedded controller service. An embedded controller service is software that executes within an embedded controller of a computer system. In a typical configuration, one embedded controller service communicates with and controls a peripheral controlled by the embedded controller, and another embedded controller service communicates with a system diagnostic service. In another typical configuration, one embedded controller service communicates with and controls a peripheral controlled by the embedded controller and communicates with a system diagnostic service. Typically, an embedded controller controls one or more system fans, and thus an embedded controller service commands the fans to turn on or off. An embedded controller service also adjusts fan speed if speed adjustments are supported by a particular fan-embedded controller combination. Typically, an embedded controller receives data from one or more sensors to detect information about a computer system. For example, an embedded controller might use a thermistor to measure a temperature of a portion of a computer system or an interior of a computer system's chassis or use a lid switch to detect whether a laptop computer's lid is in an open or closed state.

An embodiment executing in a system diagnostic service detects that a system resource usage metric is above a threshold value. A system resource usage metric is a measurement of a state or usage of a system resource. Some non-limiting examples of a system resource usage metric are processor, memory, and disk activity, and combinations thereof. One embodiment uses system resource usage data of one or more software components or processes executing in an operating system to generate a value of the system resource usage metric. For example, if five processes are currently executing, an embodiment might use processor utilization data for all five to generate a value of the system's processor utilization.

One embodiment tracks a system resource usage metric within one or more utilization categories. Some non-limiting examples of utilization categories are an idle (i.e., the system is awake but activity is below a first threshold), steady state (i.e., system activity is between the first threshold and a second, higher, threshold), peak (i.e., system activity is above the second threshold), and sleep (i.e., the system is asleep). Another embodiment tracks a system resource usage metric on an overall basis, without regard to a particular utilization category. In one embodiment, detecting that the system resource metric is above the threshold value includes detecting that the system resource metric has spent more than a predefined time in a predefined utilization category. For example, an embodiment might detect that a processor utilization metric has spent more than an hour in the peak category. Other system resource usage metrics and other tracking schemes are also possible and contemplated within the scope of the illustrative embodiments.

Responsive to detecting that the system resource usage metric is above the threshold value, an embodiment generates a maintenance notification in the system diagnostic service. In some embodiments, the maintenance notification is a dust filter notification, which notifies a user that the system dust filter requires maintenance, for example by cleaning the filter, cleaning one or more system air vents, or replacing the filter. In some embodiments, the maintenance notification notifies a user that another system component requires maintenance, for example by replacing a system battery, adding to or replacing water in a water-cooled system, and the like. Some embodiments use a notification mechanism supplied by an operating system to deliver maintenance notification from the system diagnostic service to a user. For example, the Windows operating system supports toast notifications, which are messages an application can construct and deliver to a user even when the user is not currently in the application. (Windows is a registered trademark of Microsoft Corporation in the United States and other countries.) Another embodiment uses its own notification mechanism to deliver a maintenance notification from the system diagnostic service to a user.

A maintenance notification interval is an interval between periodic maintenance notifications, for example monthly or yearly. Some systems use a maintenance notification interval with an initial or default setting based on an anticipated dust accumulation in the dust filter between filter maintenance. However, a different amount of usage than anticipated can alter anticipated dust accumulation. Similarly, some systems use a maintenance notification interval of another system component with an initial or default setting based on an anticipated amount of usage, but a different amount of usage can alter a maintenance need of the component. Thus, in some embodiments, generating a maintenance notification includes adjusting a maintenance notification interval. For example, if the system resource usage metric is processor utilization, and an embodiment has detected that processor utilization has been above 65% for more than 30 minutes, the embodiment might adjust a maintenance notification interval from monthly to bi-weekly. As another example, if the system resource usage metric is memory utilization, and an embodiment has detected that memory utilization has been above 90% for more than 45 minutes, the embodiment might adjust a maintenance notification interval from monthly to weekly. Other combinations of system resource usage metrics, durations, thresholds, and maintenance notification intervals are also possible and contemplated within the scope of the illustrative embodiments.

In some embodiments, generating a maintenance notification includes use of a trained maintenance monitoring model to generate a maintenance notification based on the model's prediction of a need for maintenance, such as a dust filter state. An embodiment trains a maintenance monitoring model to generate a dust filter maintenance notification using a training dataset. In an embodiment, the training dataset includes system resource usage data within one or more filter maintenance intervals (e.g., a week, a month, or a year) and data of a dust filter state (e.g., measured in amount of dust, a percentage reduction in airflow through the filter, or another presently available measurement) during a filter maintenance interval. During training, the model learns to predict a dust filter state from system resource usage data. Thus, once trained a maintenance monitoring model is able to predict a dust filter state from incoming system resource usage data and generate a dust filter maintenance notification when the predicted dust filter state is outside a predetermined range.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such as wires, optical fibers, microwaves, radio waves, and other electromagnetic and/or optical carriers; and/or any combination of the foregoing.

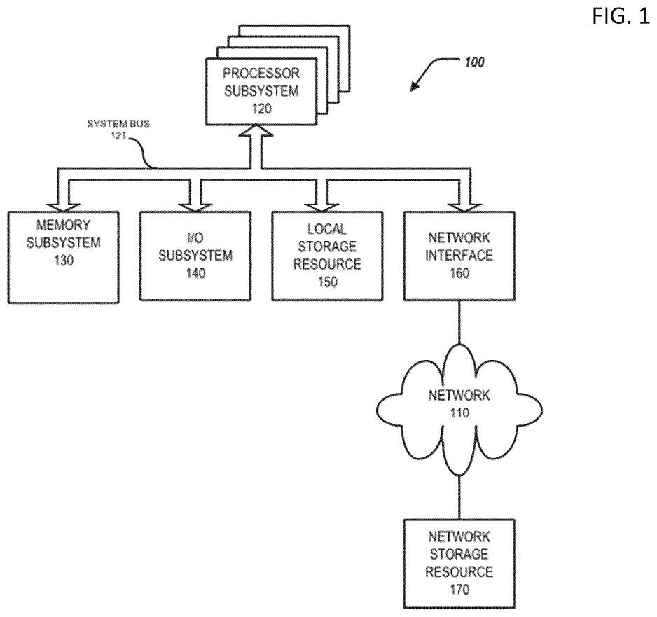

Particular embodiments are best understood by reference to FIGS. 1-5 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include one or more processing resources such as a central processing unit (CPU), microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, a camera, or another type of peripheral device.

Local storage resource 150 may comprise computer-readable media (e.g., hard disk drive, floppy disk drive, CD-ROM, and/or other types of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other types of rotating storage media, flash memory, EEPROM, and/or other types of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g., corporate) network. The network may be implemented as, or may be a part of, a storage area network (SAN), a personal area network (PAN), a local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g., customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet, or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

The information handling system 100 can also include a software application implementing a system resource usage-based maintenance reminder. The software application can be included by the memory subsystem 130. The software application can include a computer-executable program (software). The software application can be executed by the processor subsystem 120.

The information handling system 100 can also include a second software application implementing embedded controller functionality. The second software application can be in communication with the processor subsystem 120 or included in the processor subsystem 120. In some examples, the second software application is included by an embedded controller (EC) of the information handling system 100. In some examples, the second software application is included by baseband management controller of the information handling system 100.

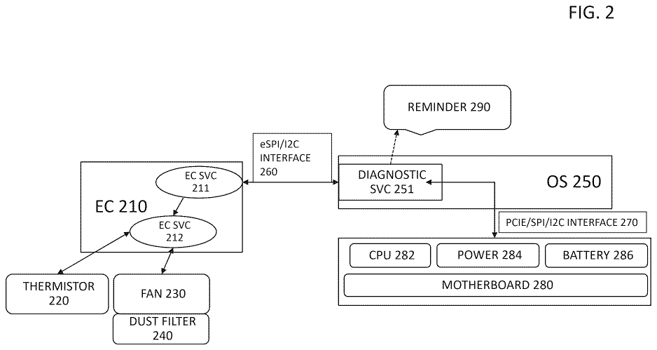

FIG. 2 illustrates a block diagram of an information handling system for a system resource usage-based maintenance reminder, according to some embodiments. In particular, FIG. 2 illustrates portions of information handling system 100 in FIG. 1.

System diagnostic service (SVC) 251 is software that executes on a computer system, under operating system (OS) 250. Diagnostic service 251 communicates over interface 270 with motherboard 280 and collects data on software executing in or installed in the computer system, such as usage data of system resources such as CPU 282, power 284, and battery 286 installed in motherboard 280.

System diagnostic service 251 also uses interface 260 to communicate with embedded controller (EC) service 211 executing in EC 210. EC service 211 communicates with EC service 212. In a typical configuration, EC service 212 communicates with and controls thermistor 220 and fan 230. Dust filter 240 is situated between fan 230 and the exterior of information handling system 100. A user is prompted to clean or replace dust filter 240 via reminder 290, a dust filter maintenance notification described elsewhere herein.

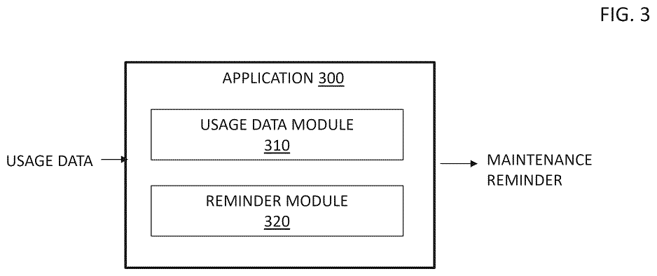

FIG. 3 depicts a block diagram of an example configuration for a system resource usage-based maintenance reminder, in accordance with an illustrative embodiment.

Application 300 executes in a system diagnostic service such as diagnostic service 251 in FIG. 2. Usage data module 310 detects that a system resource usage metric is above a threshold value. A system resource usage metric is a measurement of a state or usage of a system resource. Some non-limiting examples of a system resource usage metric are processor, memory, and disk activity, and combinations thereof. One implementation of module 310 uses system resource usage data of one or more software components or processes executing in an operating system to generate a value of the system resource usage metric. For example, if five processes are currently executing, module 310 might use processor utilization data for all five to generate a value of the system's processor utilization.

One implementation of module 310 tracks a system resource usage metric within one or more utilization categories. Some non-limiting examples of utilization categories are an idle (i.e., the system is awake but activity is below a first threshold), steady state (i.e., system activity is between the first threshold and a second, higher, threshold), peak (i.e., system activity is above the second threshold), and sleep (i.e., the system is asleep). Another implementation of module 310 tracks a system resource usage metric on an overall basis, without regard to a particular utilization category. In one implementation of module 310, detecting that the system resource metric is above the threshold value includes detecting that the system resource metric has spent more than a predefined time in a predefined utilization category. For example, module 310 might detect that a processor utilization metric has spent more than an hour in the peak category. Other system resource usage metrics and other tracking schemes are also possible.

Responsive to detecting that the system resource usage metric is above the threshold value, reminder module 320 generates a maintenance notification in the system diagnostic service. In some implementations of module 320, the maintenance notification is a dust filter notification, which notifies a user that the system dust filter requires maintenance, for example by cleaning the filter, cleaning one or more system air vents, or replacing the filter. In some implementations of module 320, the maintenance notification notifies a user that another system component requires maintenance, for example by replacing a system battery, adding to or replacing water in a water-cooled system, and the like. Some implementations of module 320 use a notification mechanism supplied by an operating system to deliver maintenance notification from the system diagnostic service to a user. For example, the Windows operating system supports toast notifications, which are messages an application can construct and deliver to a user even when the user is not currently in the application. Another implementation of module 320 uses its own notification mechanism to deliver a maintenance notification from the system diagnostic service to a user.

A maintenance notification interval is an interval between periodic maintenance notifications, for example monthly or yearly. Some systems use a maintenance notification interval with an initial or default setting based on an anticipated dust accumulation in the dust filter between filter maintenance. However, a different amount of usage than anticipated can alter anticipated dust accumulation. Similarly, some systems use a maintenance notification interval of another system component with an initial or default setting based on an anticipated amount of usage, but a different amount of usage can alter a maintenance need of the component. Thus, in some implementations of module 320, generating a maintenance notification includes adjusting a maintenance notification interval. For example, if the system resource usage metric is processor utilization, and module 320 has detected that processor utilization has been above 65% for more than 30 minutes, module 320 might adjust a maintenance notification interval from monthly to bi-weekly. As another example, if the system resource usage metric is memory utilization, and module 320 has detected that memory utilization has been above 90% for more than 45 minutes, module 320 might adjust a maintenance notification interval from monthly to weekly. Other combinations of system resource usage metrics, durations, thresholds, and maintenance notification intervals are also possible.

In some implementations of module 320, generating a maintenance notification includes use of a trained maintenance monitoring model to generate a maintenance notification based on the model's prediction of a need for maintenance, such as a dust filter state. Module 320 trains a maintenance monitoring model to generate a dust filter maintenance notification using a training dataset. In an implementation of module 320, the training dataset includes system resource usage data within one or more filter maintenance intervals (e.g., a week, a month, or a year) and data of a dust filter state (e.g., measured in amount of dust, a percentage reduction in airflow through the filter, or another presently available measurement) during a filter maintenance interval. During training, the model learns to predict a dust filter state from system resource usage data. Thus, once trained a maintenance monitoring model is able to predict a dust filter state from incoming system resource usage data and generate a dust filter maintenance notification when the predicted dust filter state is outside a predetermined range.

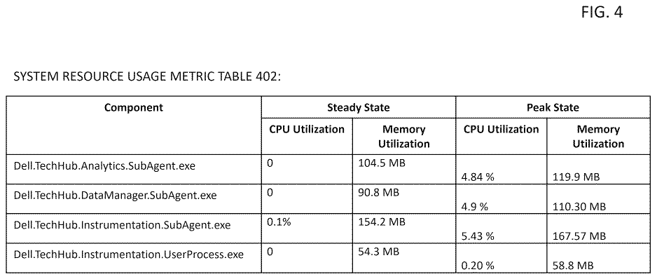

FIG. 4 depicts an example of a system resource usage-based maintenance reminder, in accordance with an illustrative embodiment. The example can be executed using application 300 in FIG. 3.

System resource metric table 402 depicts CPU and memory utilization for example software components in a steady state and peak states. Application 300 uses data such as data in table 402 to detect that a system resource usage metric is above a threshold value.

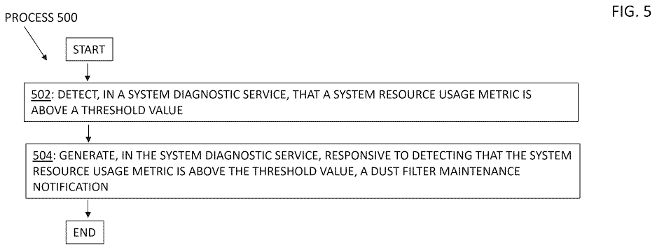

FIG. 5 depicts a flowchart of an example process for a system resource usage-based maintenance reminder. in accordance with an illustrative embodiment. Process 500 can be executed by application 300 in FIG. 3.

In block 502, the process detects, in a system diagnostic service, that a system resource usage metric is above a threshold value. In block 504, the process generates, in the system diagnostic service, responsive to detecting that the system resource usage metric is above the threshold value, a dust filter maintenance notification. Then the process ends.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

1. A computer-implemented method comprising:
computing, in a system diagnostic service executing in a computer system, a system resource usage metric from usage data of at least one system resource used by software executing in the computer system, the usage data comprising at least one of processor usage, memory usage, storage usage, and power usage;
detecting, in the system diagnostic service, that the system resource usage metric is above a threshold value;
adjusting, in the system diagnostic service, responsive to detecting that the system resource usage metric is above the threshold value, according to the system resource usage metric, an interval between periodic dust filter maintenance notifications;
generating, in the system diagnostic service, according to the adjusted interval between periodic dust filter maintenance notifications, system dust filter maintenance notification; and
delivering, from the system diagnostic service using a notification mechanism supplied by an operating system, the dust filter maintenance notification to a user.

2. The computer-implemented method of claim 1, further comprising:
generating, using system resource usage data of a software component executing in an operating system, a value of the system resource usage metric.

3. The computer-implemented method of claim 2, wherein the system resource usage data is collected by the system diagnostic service.

4. The computer-implemented method of claim 1, wherein detecting that the system resource usage metric is above the threshold value comprises detecting that the system resource usage metric has spent more than a predefined time in a predefined utilization category.

5. The computer-implemented method of claim 1, wherein generating the dust filter maintenance notification comprises adjusting a maintenance notification interval.

6. The computer-implemented method of claim 1, wherein generating the dust filter maintenance notification comprises predicting, using a trained maintenance monitoring model, a dust filter maintenance state, the trained maintenance monitoring model trained to predict a dust filter state from system resource usage data.

7. The computer-implemented method of claim 6, further comprising:
training, using a training dataset comprising dust filter maintenance interval data, system resource usage data within a dust filter maintenance interval, and data of a dust filter state during the dust filter maintenance interval, a maintenance monitoring model, the training resulting in the trained maintenance monitoring model.

8. An information handling system comprising a processor having access to memory media storing instructions executable by the processor to perform operations, comprising:
computing, in a system diagnostic service executing in a computer system, a system resource usage metric from usage data of at least one system resource used by software executing in the computer system, the usage data comprising at least one of processor usage, memory usage, storage usage, and power usage;
detecting, in the system diagnostic service, that the system resource usage metric is above a threshold value;
adjusting, in the system diagnostic service, responsive to detecting that the system resource usage metric is above the threshold value, according to the system resource usage metric, an interval between periodic dust filter maintenance notifications;
generating, in the system diagnostic service, according to the adjusted interval between periodic dust filter maintenance notifications, a dust filter maintenance notification; and
delivering, from the system diagnostic service using a notification mechanism supplied by an operating system, the dust filter maintenance notification to a user.

9. The information handling system of claim 8, further comprising:
generating, using system resource usage data of a software component executing in an operating system, a value of the system resource usage metric.

10. The information handling system of claim 9, wherein the system resource usage data is collected by the system diagnostic service.

11. The information handling system of claim 8, wherein detecting that the system resource usage metric is above the threshold value comprises detecting that the system resource usage metric has spent more than a predefined time in a predefined utilization category.

12. The information handling system of claim 8, wherein generating the dust filter maintenance notification comprises adjusting a maintenance notification interval.

13. The information handling system of claim 8, wherein generating the dust filter maintenance notification comprises predicting, using a trained maintenance monitoring model, a dust filter maintenance state, the trained maintenance monitoring model trained to predict a dust filter state from system resource usage data.

14. The information handling system of claim 13, further comprising:
training, using a training dataset comprising dust filter maintenance interval data, system resource usage data within a dust filter maintenance interval, and data of a dust filter state during the dust filter maintenance interval, a maintenance monitoring model, the training resulting in the trained maintenance monitoring model.

15. A non-transitory computer-readable medium storing software comprising instructions executable by one or more computers which, upon such execution, cause the one or more computers to perform operations comprising:
computing, in a system diagnostic service executing in a computer system, a system resource usage metric from usage data of at least one system resource used by software executing in the computer system, the usage data comprising at least one of processor usage, memory usage, storage usage, and power usage;
detecting, in the system diagnostic service, that the system resource usage metric is above a threshold value;
adjusting, in the system diagnostic service, responsive to detecting that the system resource usage metric is above the threshold value, according to the system resource usage metric, an interval between periodic dust filter maintenance notifications;
generating, in the system diagnostic service, according to the adjusted interval between periodic dust filter maintenance notifications, dust filter maintenance notification; and
delivering, from the system diagnostic service using a notification mechanism supplied by an operating system, the dust filter maintenance notification to a user.

16. The non-transitory computer-readable medium of claim 15, further comprising:
generating, using system resource usage data of a software component executing in an operating system, a value of the system resource usage metric.

17. The non-transitory computer-readable medium of claim 16, wherein the system resource usage data is collected by the system diagnostic service.

18. The non-transitory computer-readable medium of claim 15, wherein detecting that the system resource usage metric is above the threshold value comprises detecting that the system resource metric has spent more than a predefined time in a predefined utilization category.

19. The non-transitory computer-readable medium of claim 15, wherein generating the dust filter maintenance notification comprises adjusting a maintenance notification interval.

20. The non-transitory computer-readable medium of claim 15, wherein generating the dust filter maintenance notification comprises predicting, using a trained maintenance monitoring model, a dust filter maintenance state, the trained maintenance monitoring model trained to predict a dust filter state from system resource usage data.
